(19) United States
(12) Patent Application Publication
(10) Pub. No.: US 2006/0251294 A1
(43) Pub. Date: Nov. 9, 2006

(54) System and method for dynamically analyzing a mobile object

(75) Inventors: David R. Soll, Iowa City, IA (US); Edward R. Voss, Coralville, IA (US)

Correspondence Address: SCHWEGMAN, LUNDBERG, WOESSNER & KLUTH, P.A., P.O. BOX 2938, MINNEAPOLIS, MN, 55402, US

(73) Assignee: University of Iowa Research Foundation

(21) Appl. No.: 11/479,210

(22) Filed: Jun. 30, 2006

Related U.S. Application Data
(63) Continuation of application No. 10/210,334, filed on Aug. 1, 2002, now abandoned.

(51) Int. Cl. G06K 9/00

(52) U.S. Cl. 382/107; 382/128

(57) ABSTRACT

A system and method for dynamically analyzing a mobile object. One embodiment of the invention provides a computerized method that includes obtaining a plurality of digital representations of the mobile object, establishing a first and a second processing station in a session, processing the digital representations on the first processing station, processing in parallel the digital representations on the second processing station to compute a plurality of parameters representing a motility or morphology of the mobile object, and displaying a graphical reconstruction of the mobile object. In one implementation, the computerized method further includes establishing one or more control panels to control various functionalities of the first and second processing stations. In another implementation, the computerized method further includes preserving the first and second processing stations in the session.

Portions of the present invention were made with support of the United States Government via a grant from the National Institutes of Health under contract No. 1 2502100. The U.S. Government therefore may have certain rights in the invention.

### FIELD OF THE INVENTION

The present invention relates generally to motion analysis, and more particularly to a system and method for dynamically analyzing a mobile object.

### BACKGROUND INFORMATION

The analysis of the behavior of motile, living cells using computer-assisted systems comprises a crucial tool in understanding, for example, the reasons why cancer cells become metastic, the reasons why HIV infected cells do not perform their normal functions, and the roles of specific cytoskeletal and signaling molecules in cellular locomotion during embryonic development and during cellular responses in the immune system. Further, motion analysis systems have been used to analyze the parameters of the shape and motion of objects in a variety of diverse fields. For example, such systems have been used for analysis of such diverse dynamic phenomena as the explosion of the space shuttle Challenger, echocardiography, human kinesiology, insect larvae crawling, sperm motility, bacterial swimming, cell movement and morphological change, shape changes of the embryonic heart, breast movement for reconstructive surgery, and the like. Often times, the information required to analyze such systems requires manual gathering of data. For example, in analyzing embryonic heart action, a researcher would display an echocardiograph of a heart on a monitor and make measurements of the monitor using a scale, or the like, held up to the screen. The tedious and time consuming nature of these types of manual measurements severely limits the practicality of such an approach.

Certain analysis systems have been developed for the biological study of cell motility and morphology. However, many of these systems have lacked the ability to fully capture every aspect of the dynamic morphology of a moving object. In addition, many of these systems have implemented an approach whereby functions are performed sequentially. Nothing can be done out of turn, and each function must be completed before a successive function can be initiated. At a practical level, this means that a tape or live preparation must be first digitized, then processed, then edge detected, etc. This sequential process can take hours. If, at any stage of this linear process, one discovers a defect, one must return to the defect point and begin again.

For the reasons stated above, and for other reasons stated below which will become apparent to those skilled in the art upon reading and understanding the present specification, there is a need for the present invention.

### SUMMARY OF THE INVENTION

To address these and other needs, various embodiments of the present invention are provided. One embodiment of the invention provides a computerized method for dynamically analyzing a mobile object. In this embodiment, the computerized method includes obtaining a plurality of digital representations of the mobile object, establishing a first and a second processing station in a session, processing the digital representations on the first processing station, processing in parallel the digital representations on the second processing station to compute a plurality of parameters representing motility or morphology of the mobile object, and displaying a graphical reconstruction of the mobile object. In one implementation, the computerized method further includes establishing one or more control panels to control various functionalities of the first and second processing stations. In another implementation, the computerized method further includes preserving the first and second processing stations in the session.

Another embodiment of the invention provides a computerized method for dynamically analyzing a mobile object in three dimensions. In this embodiment, the computerized method includes obtaining a plurality of digital representations of the mobile object, establishing a first and a second processing station in a first session, processing the digital representations on the first processing station, simultaneously processing the digital representations on the second processing station, displaying a three-dimensional graphical reconstruction of the mobile object, and preserving the first and second processing stations in the first session.

Another embodiment of the invention provides a method for processing a series of digital representations of a mobile object on a display, in a computerized system having a graphical user interface including the display and a pointing device. In this embodiment, the method includes displaying a session, displaying a first and a second processing station within the session, dragging and dropping the series of digital representations onto both the first and second processing stations, processing the series of digital representations on the first processing station, processing in parallel the series of digital representations on the second processing station, and displaying a graphical reconstruction of the moving object.

These and other embodiments will be described in the detailed description below.

### BRIEF DESCRIPTION OF THE DRAWINGS

FIG. 1 illustrates a system including a bank of parallel processors according to one embodiment of the present invention.

FIG. 2A illustrates a system including a series of processing nodes according to one embodiment of the present invention.

FIG. 2B illustrates a system including a series of nodes coupled to an Ethernet hub, according to one embodiment of the present invention.

FIG. 3 illustrates a complex processing station, according to one embodiment of the present invention.

FIG. 4 illustrates an image processing station, according to one embodiment of the present invention.

FIG. 5 illustrates an outlining mechanism for reconstructing fibrous structures, according to one embodiment of the present invention.

FIG. 6 illustrates a table that includes a non-exclusive list of parameters that are computed by the system, according to one embodiment of the present invention.

FIG. 7 illustrates a notebook page, according to one embodiment of the present invention.

FIG. 8 illustrates a drag-and-drop operation of one or more digital representations into an image processor, according to one embodiment of the present invention.

FIG. 9 illustrates a panel of controls in a single processing station, according to one embodiment of the present invention.

FIG. 10 illustrates a drag-and-drop operation of one or more digital representations into a stack of processing stations, according to one embodiment of the present invention.

FIG. 11 illustrates a drag-and-drop operation of a stack of processing stations over one or more digital representations, according to one embodiment of the present invention.

FIG. 12 illustrates a drag-and-drop operation of one or more digital representations into a station that computes motility parameters, according to one embodiment of the present invention.

FIG. 13A through 13F illustrate a series of views along a trajectory, in which a viewer moves continuously closer to the underside of a live mammary tumor cell reconstructed in 3D, according to one embodiment of the present invention.

### DETAILED DESCRIPTION

A novel system and method for dynamically analyzing a mobile object is described herein. In the following detailed description of the embodiments, reference is made to the accompanying drawings which form a part hereof, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the present inventions. It is also to be understood that the various embodiments of the invention, although different, are not necessarily mutually exclusive. For example, a particular feature, structure or characteristic described in one embodiment may be included within other embodiments. The following description is, therefore, not to be taken in a limiting sense.

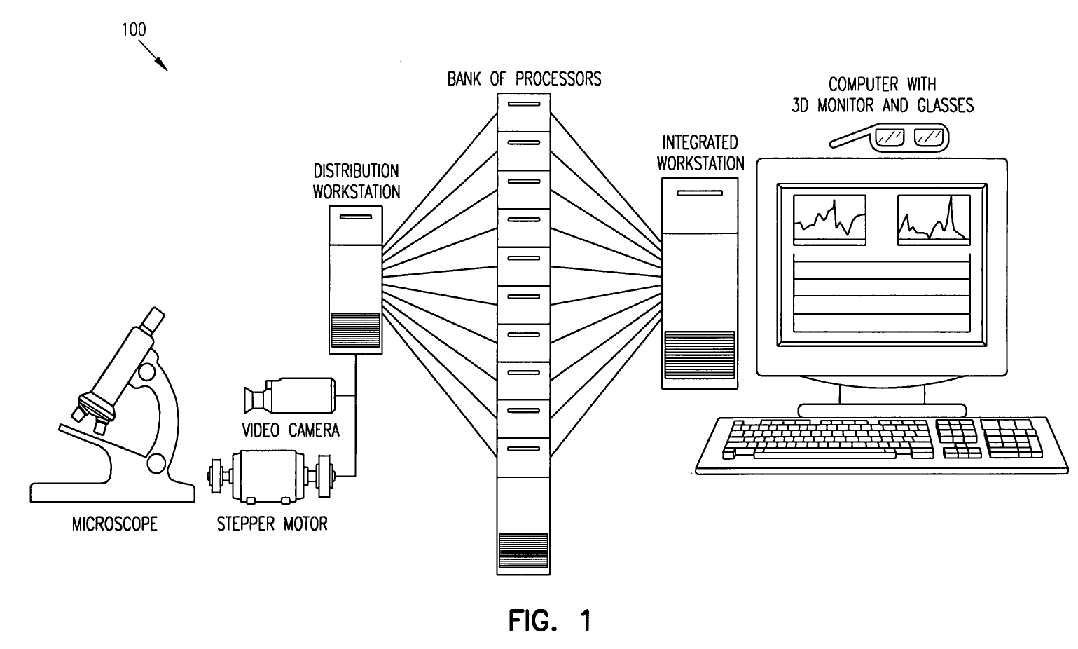

FIG. 1 illustrates a system including a bank of parallel processors according to one embodiment of the present invention. In this embodiment, system 100 includes hardware and software components. A cell preparation, usually in a chamber, is positioned on the stage of a microscope. To obtain optical sections, a computer-regulated MicroStep Z3DI microstepper motor is used with an inverted Zeiss microscope equipped with DIC optics, and the more advanced MicroStep Z3DII microstepper motor is used with the NORAN OZ LSCM. The microstepper motor moves the focal plane through a desired distance either at a constant rate or through steps. A character generator is inserted into the video path to provide synchronization information. Optical sections are either digitally captured immediately or videorecorded and digitally captured at a later time. The system is programmable for speed, increment height, and number of increments. For a human polymorphonuclear leukocyte, human T cell, human dendritic cell, Dictyostelium amoeba or invasive neoplastic cell moving on a flat surface (e.g., a microscope slide or chamber wall), thirty optical sections at 0.5 to 1.0 μm intervals within a two second time interval are effective both in handling maximum height and restricting motion artifacts to less than 5% volume (25). For HIV-induced T cell syncytia, which can be greater than 30 μm high (z-axis), either the distance interval or number of intervals must be increased proportionately. The optical sections are read into a computer using a frame grabber, thereby generating a QuickTime® movie (in one implementation). The QuickTime movie is synchronized automatically by means of the character generator information to the up and down scans, and the times of the scans are recorded in an auxiliary synchronization file. The frames of the QuickTime movie are then extracted into a customized movie format from which the user can select the number of optical sections to be used in reconstructions, the interval between reconstructions, the number of sections for image averaging, and the image processing regime, if necessary. In some embodiments, a series of digital representations are used, such as JPEG or TIFF files (for example), rather than a QuickTime® movie. For example, a user could import a series of JPEG files into the system via an external interface, such as an external file system, or across the Internet.

In one embodiment, system 100 obtains optical sections of a moving cell within a time period short enough so that the amount of translocation of the cell between the first and last section does not lead to significant reconstruction artifacts. In this embodiment, functional steps are included to repeat the reconstruction process at short enough time intervals so that the behavioral changes of interest can be analyzed, to reconstruct not only the 3D surface of the cell, but also subcellular compartments, zones, vesicles, vacuoles and molecular complexes, to view the reconstructions dynamically (as a time series movie) in 3D on a stereo workstation, and to compute 3D motility and dynamic morphology parameters of the whole cell as well as each subcellular compartment.

System 100 implements a sophisticated parallel processing environment, and includes a bank of processors. (As available processor speeds increase, some embodiments may, however, need only utilize a single-processor implementation). A distributed processor makes scalable processing power available through a network of computers. This means that system 100 is able to export tasks that require extensive processing to other computers on the network. For example, when a user adjusts a control and sees the change immediately in the processing of the movie of the cell in one format, the distributed processors can perform the same change on the remaining unseen frames. Communication among processor nodes is preformed, in one implementation, with a Gbit Ethernet fiber-optic connection. This architecture has several attributes. First, it provides speed. Second, the architecture is scalable, which means additional computers or storage elements can be added to the cluster for additional computing power. Third, this architecture keeps costs low because it is based on inexpensive consumer technologies. Finally, this system will naturally improve with time because consumer technologies are evolving so rapidly for speed and storage.

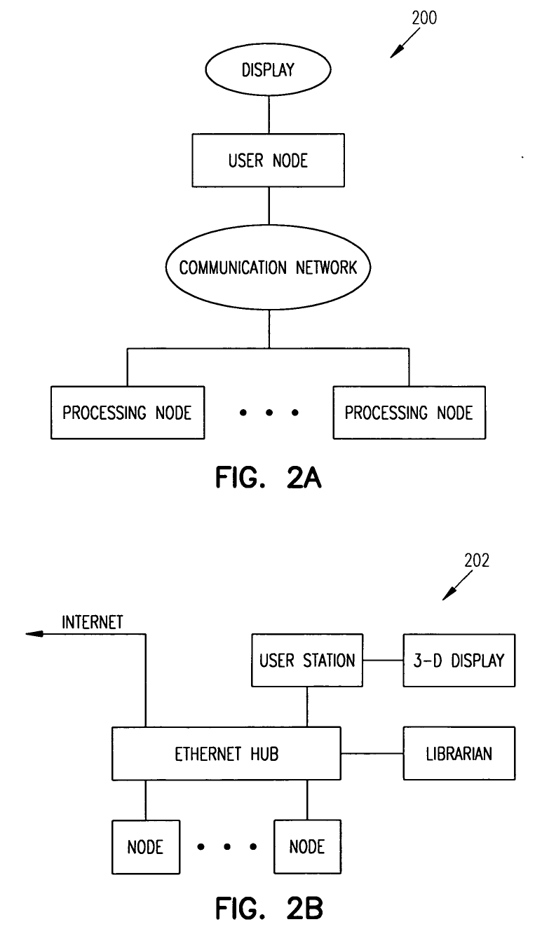

FIG. 2A illustrates a system including a series of processing nodes according to one embodiment of the present invention. In this embodiment, system 200 includes a display, a user node, a communication network, and a series of processing nodes. The display is coupled to the user node, and the user node is coupled to the communication network. Each of the processing nodes are also coupled to the communication network, and thus operatively coupled to the user node. In one implementation, the communication network includes fast Gbit Ethernet connectivity.

FIG. 2B illustrates a system including a series of nodes coupled to an Ethernet hub, according to one embodiment of the present invention. In this embodiment, system 202 includes an Ethernet hub coupled to an Internet connection, a user station, a 3D display, a librarian, and a number of nodes. The nodes, librarian, and user station are each coupled to the Ethernet hub. The 3D display is coupled to the user station. System 202 provides a kernel that transfers files via the URL network addressing protocol. In one implementation, system 202 includes JAVA software, which aids in the design of network-distributed processing. System 202 will appoint the librarian (one of the distributed computers) to contain all currently active files and processing tasks. Each file and task has a “check-out card” associated with it, which can be checked out by a cluster node that is currently inactive. These checkout cards will allow system 202 to know which tasks have been completed and which tasks are being worked on. The advantage of this strategy is its simplicity and robustness (fault tolerance). Heavy duty (enterprise) network-based applications generally pass a large number of small messages. In system 202, the information includes image content of appreciable size. The ratio of information size to library card size is, therefore, high. In an alternate embodiment, RMI (Remote Method Invocation) or XML (Extensible Markup Language) mechanisms may be used instead.

In one embodiment, the software includes JAVA code, using JFC® (Java Foundation Classes) as the GUI (Graphical User Interface). Mac OS X, Windows 2000, Windows XP, and LINUX all provide excellent support for JAVA. This embodiment provides a state of the art GUI that has full support for platform independent management for visual display and user interaction. The system is multi-threaded, and implements the base classes “Media” and “Content” that manage presentation and functionality. These base classes are integrated into the JFC environment via a collection of JAVA interfaces.

Some embodiments provide a drag-and-drop “processor station” user interface. This interface is more than just look-and-feel. It is integral to the functionality of the system. Movies may be dragged into image processors, then into outliners, then 3D reconstructors, and finally data visualizers. Each drag-and-drop operation immediately updates the image, modified by the many drop-down control panels in each processing station. This provides computing-on-demand. When a movie is played, or is single-framed back and forth, the computations are redone as required. These embodiments operate on Windows 2000 and Windows XP using IBM's JDK1.3 virtual machine.

The hardware and software environments of various embodiments require that basic operations be tightly integrated within a high performance kernel. This kernel is a master switchboard, which manages the Graphics User Interface (GUI) and the stations for processing, along with all communications between stations. Because the kernel is small and compactly integrated, it is fast. It separates the basic features of image manipulation, “look-and-feel” and “messaging”, from the more advanced modules that form the “meat” of the system. The basic kernel manipulates images, maintains processing stations, and directs the “drag and drop” interface required for the “Notebook” format (described in more detail below). This kernel also includes multithreaded capabilities and message handling, and also advanced image processing functions. These augmented features support the efficacy of the design of the system. The system may then utilizes an enhanced dual processor kernel, which runs separate groups of threads on dual processors. The techniques developed for the dual kernel may then be applied to a network of processors. JAVA has features that make this particularly efficient. Because JAVA handles components on a single machine, via URL, in the same manner as it does components on other machines, there is no crucial difference between dual processing and networking.

In one embodiment, the system combines the following steps into one: setting up the stepper motor, recording onto video tape (¾ inch analog or DV), transferring video to the computer (via a frame grabber), and generating a QuickTime® movie. The stepper motor is controlled directly from the computer by JAVA using a serial port and a JAVA JNI (Java Native Environment) module, thus eliminating the need for the character generator sync box. A Data Translation® frame grabber on a dual processor computer is used, one processor being used to grab the frame, and the other to compress and save the frames. The video is displayed directly on the computer screen, eliminating the need for a TV monitor, and allowing the user to see exactly what image will be obtained. Optionally, a real-time module shows 3D reconstructions and 3D data plots on a second monitor while the images are being acquired on the first monitor.

The “computation-on-demand” paradigm of various embodiments greatly facilitates computation processes. The system, having an object-oriented, thread-based design, devotes the power of the main processor to the immediate, visual task at hand, and then completes the full tasks by enlisting other networked machines or processors (by means of a distributed cluster). One implementation utilizes several dual-processor machines each having 120 GB IDE hard drives. The user is able to “synchronize” their original video data on each cluster machine, having the cluster transfer the data from the controlling machine (the “Librarian”) to each cluster node prior to an interactive session. Another implementation utilizes a fiber-optic gigabit (Gbit) network, which is fast enough to send video in real-time.

As discussed, various embodiments of the invention provide real-time user interaction, computing-on-demand, and integration of data into “notebooks”. A single notebook contains one or more experiments (via links to files on the hard drive, CD-ROM's, or the Internet) at various stages of completion, with exactly the same settings for all the processing stations just as the user last left them. This is achieved by using Java's serialization feature, as customized by the kernel. A given notebook can contain virtually hundreds of experiments in this fashion. The system also provides an infrastructure in which to implement evolving, up-to-date algorithms for image processing, outlining, 3D reconstruction, motion analysis, and the like.

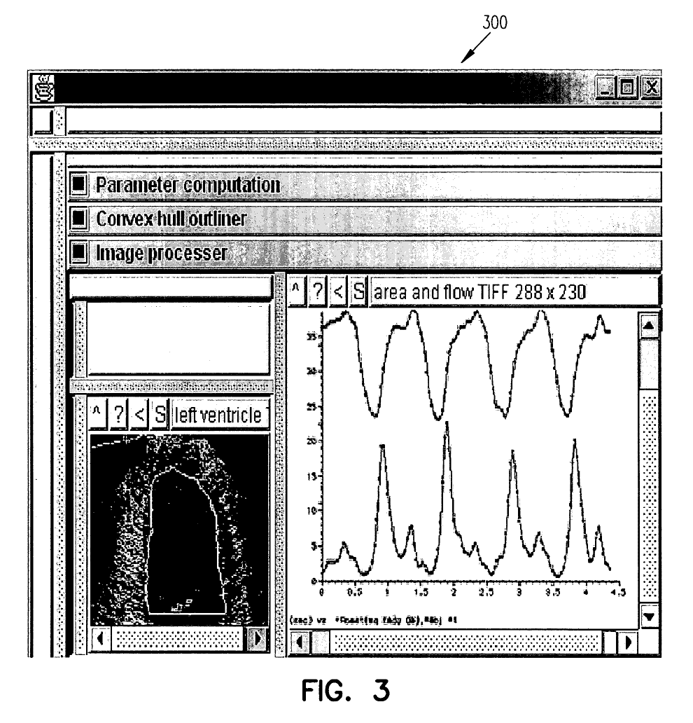

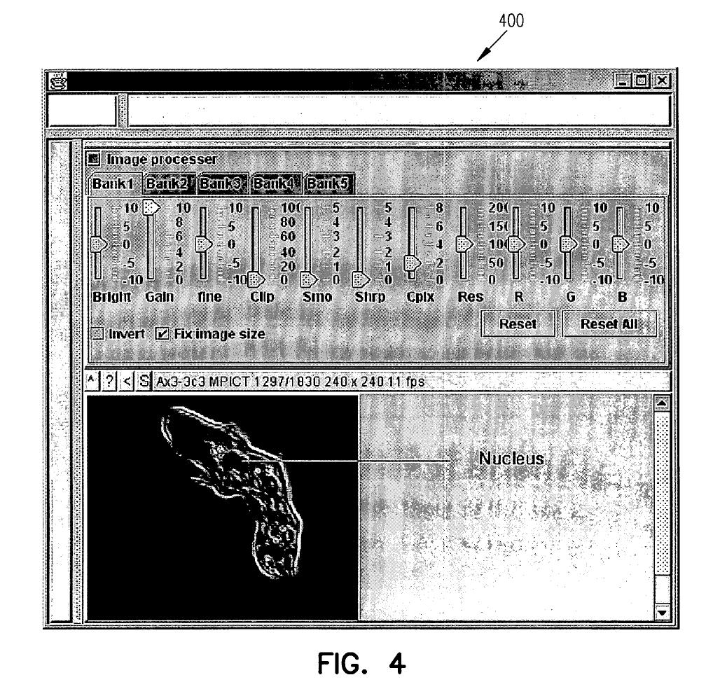

FIG. 3 illustrates a complex processing station, according to one embodiment of the present invention. In this embodiment, window 300 includes an example of a complex processing station. A processing station is a window-embodied function that is able to process information. Either one drags information into the station for processing, or the station is dragged over information for processing. Stations can be dragged into other stations creating a “media processing complex” which performs the combined nested processes. Therefore, a user can customize their own processing stations and save them for later use to perform any imaginable combination of functions. For instance, if one wished to compute two parameters of heart function, one would simply drag the customized media processing complex over the dynamic heart image movie to perform the following functions: image processing, outlining, motion analysis (computation of two parameters of heart function) and data display. All functions would be transparent to the user, who would see only the final computations or processed image. In the example shown in FIG. 3, the complex processing station includes an outlined left ventricle of a human heart in the left window, while dynamically computing volume and net flow as functions of time in the right window.

FIG. 4 illustrates an image processing station, according to one embodiment of the present invention. In this embodiment, window 400 includes an example of a typical image processing station (for edge enhancement, in this case). Image processing stations perform tasks that prepare an image for automatic outlining and 3D reconstruction. In most cases, this involves enhancing image quality. Images are enhanced by contrast/brightness manipulations, and a variety of additional pixel intensity-based processing techniques, including histogram equalization, intensity thresholding and multi-band color correction, for example. Images can also be enhanced by applying filters for smoothing, sharpening, edge detection, noise removal, median filtering, and 2D or 3D Fourier transform techniques for deconvolution. Finally, images can be geometrically corrected using image registration (matching two images using known fixed markers) and unwarping, which is also a “straightening” feature. An image processing station also contains functions for compressing images in order to optimize data storage using a variety of techniques including JPEG compression, which employ discrete cosine transforms or wavelet transforms. An example of an edge-enhancing processing station is shown in FIG. 4. The processing station contains five banks of controls, and is positioned within a notebook. In this case, the processed DIC image is enhanced such that one can discriminate the nucleus, particulate-free cytoplasmic zone of the anterior pseudopod, microtubules and vesicles, all in one optical section of a living, crawling cell.

Outlining is the heart of motion analysis. The quality not only of the reconstructions, but also the quality of the motion analysis data and the ability to generate cohesive translocation paths ultimately depends on robust outlining methods. The selection of an outlining method is keyed to the type of image and microscopy employed, and to experimental expectations. In some cases, such as the left ventricle of the heart, the robustness of the method is more important than fine detail, and the fact that the outlines are dynamic, and not static, adds to the level of information that is obtained. In contrast, fine detail takes precedent in images of such structures as dendritic processes. In some cases, two different methods may have to be applied to obtain an outline within an outline, such as a nucleus in a cell, where the refractive differences of the two perimeters may allow separation. “Nested” processing stations within a notebook provide the capability to achieve this in various implementations. Outlining must also be automated whenever possible because of the large number of outlines required for 3D reconstructions and because automated outlining reduces human error and subjectivity. Several outlining methods exist in various embodiments of the system (implemented within outlining processing stations), including outlining mechanisms for fiber networks and amorphous objects. These combined outlining methods comprise an outlining suite.

One outlining method that is supported by certain embodiments is the thresholding method. Thresholding is the simplest way of providing an outline based on pixel intensity. Given a single threshold value, a boundary is formed between intensities above and below. Certain embodiments include outlining processing stations that provide the ability for multiple thresholding.

Another supported method is the gradient outlining method. In the gradient method, the steepness of change in intensity is interpreted. The threshold in this case is a particular “steepness.” An edge will have a sharp drop off, while fuzzy areas will not. This method has the advantage that all identified edges need not be of the same intensity. New algorithms have been developed to fill outline gaps, in order to improve performance in instances of uneven lighting.

A “complexity” method for outlining is also supported in various embodiments to automatically outline DIC images. The edges of DIC images are soft and shadowed, and therefore, not readily identified by either the thresholding or gradient outlining method. Therefore, the “complexity” method outlines in-focus detail. This method provides automated 3D reconstruction of DIC-imaged cells. The enhanced complexity method allows (in some cases) discrimination of the outer cell surface and the nuclear surface of a crawling cell. In some embodiments, texture detection algorithms are used as another way to compute outlines by detecting in-focus detail. In some embodiments, the complexity method is controllable in real-time from a processing station. The 3D results can be viewed as the complexity controls are manipulated.

Another outlining method that is supported is the method of outlining interior “holes”. As an example, the nucleus and the particulate-free zone of a pseudopod are regions that lack detail—i.e., “holes”. Using the interior “hole” method, a center point is selected, and the image is turned inside-out around that point. This is done by inversion through a circle, that is, mapping a point (r, θ) in polar coordinates to (c*1/r, θ), where c is a constant large enough to make the desired region to be outlined convex. The inside-out image is then outlined by the threshold method and the convex hull of the outline is computed. The outline is then re-inverted to correspond to the original image. This method, when combined with the complexity outlining method, will allow automatic outlining of the nuclei of embryonic cells, as well as the nucleus of an independently crawling cell. In one embodiment, this outlining method supports an arbitrary combination of inner and outer outlining, even within one object. In some embodiments, the method supports inner outlining directly in three dimensions, using spherical coordinates and convex surfaces, rather than the slice-by-slice 2D outlines.

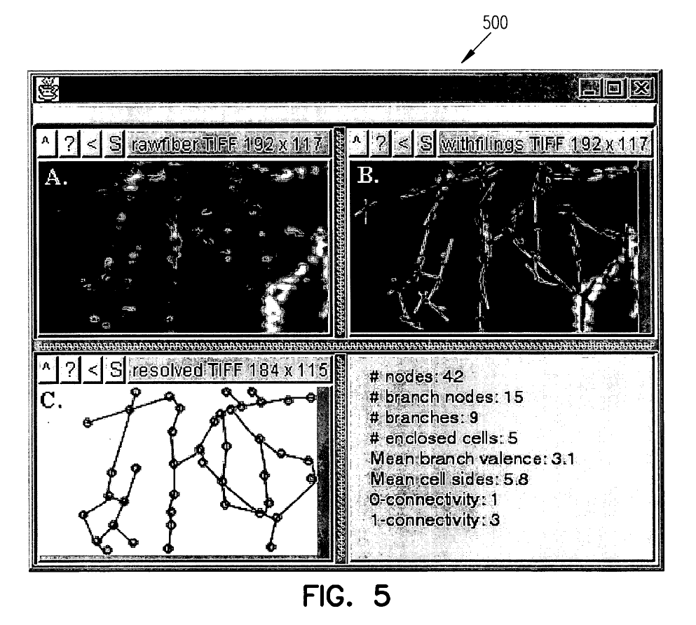

FIG. 5 illustrates an outlining mechanism for reconstructing fibrous structures, according to one embodiment of the present invention. In this embodiment, window 500 includes an example of such an outlining method. In this method, fibrous images with short stretches of greater and lesser intensity become “magnetized” by computer modeling. The intensity of the magnetic force is proportional to in focus pixel intensity. “Iron filings” are dusted across the entire image. They pile up more densely and in an oriented fashion at the more intensely stained stretches and begin to fill in the gaps. The user controls the size and number of iron filings. Nodes are then added to bifurcations and points of angle change. This represents, in essence, a “curve-rectification” algorithm. The method is implemented for both 2D and 3D analysis. Because the final model is a “graph” (in the mathematical sense), the techniques of “graph theory” are used to generate parameters. Graph theory represents, presently, one of the most active areas of research for computer-related mathematics. Some of the parameters that are computed are the following: branch complexity; number of enclosed “cells” (areas completely encapsulated in the fiber network); number of nodes; connectivity, number of branch ends; rate of branch end growth; motion parameters for enclosed cells and nodes; interior cell morphologies; directionality, and expansion, contraction, dislocation, and twisting (torsion coefficients) of the entire graph.

Another type of processing station that is supported in various embodiments of the invention is the “vectoring” station. Some fluorescently tagged complexes are so amorphous as to defy outlining. This has already been found to be the case for the edges of poor quality echocardiograms of the left ventricle of the human heart and groups of coordinately migrating cells imaged at low magnification. The dynamic behavior of such objects can, however, be analyzed by the “vector flow” plots, which are effective in analyzing poor images of the heart wall, the behavior of large numbers of cells at low magnification, and cytoplasmic flow. The pattern-matching method for computing the vectors in two dimensions extends to three dimensions, comparing cublets of detail in successive 3D frames to find a “best match” direction. In addition, there are a number of more sophisticated vectoring techniques, such as Boyce Block Matching, and the Wiener Based Motion Estimator, which are also implemented as vectoring stations. In one embodiment, vectoring is integrated with outlining so that an object that is partly capable of being outlined and partly amorphous can be viewed as a combination of direct reconstruction, caging (faceting), and vectoring, all in one 3D image. The result of vectoring is enhanced to allow vectors to be viewed as red-blue “doppler” regions.

Another processing station that is supported in various embodiments is the 3D-rendering station. 3D rendering takes a stack of outlines and creates from them a visible 3D display of the reconstructed object. In the simplest rendition, a stack of “ribbons” is obtained that represent the outlines of the optical sections. In this case, no attempts are made to connect the ribbons, or perimeter points in the z-axis to encapsulate the object. In one implementation, OpenGL® is used for implementing certain rendering techniques.

Certain embodiments of the invention support direct image reconstruction, faceting, and various combinations of the two. For reconstruction, the determined outlines of the sets of optical sections at each time interval are stacked. The contours in the stacked image are separated by distance intervals proportional to the original distances in the z-axis. To enclose a cell and, at the same time, convert it to a mathematical 3D model which can be used for computing both 3D motility and dynamic 3D morphology parameters, a wrapping algorithm (in one implementation) can be applied that involves two phases, a “top wrap” and a “bottom wrap” joined at the seam. This procedure results in a “faceted image”, or a “caged image”, of the cell at each time point. In its simplest presentation, one can view the faceted image from any angle. Although a faceted image provides a 3D reconstruction which approximates the shape of a living, moving cell, the transparency of the image sometimes confuses interpretations of the closest and farthest faceted surfaces, especially in pseudo-3D reconstructions. This in turn confuses interpretation of behavior, especially the temporal changes in pseudopod extension and retraction. Nontrasparent wrapped images (also referred to simply as “wrapped images”) usually provide a more realistic reproduction of a cell. By light-shading these images, extraordinary views are provided of contour changes at the cell surface.

Other embodiments may implement different variations of reconstruction, such as direct image reconstruction. Upon completion of outlining, the digital representations contain both the computer-interpreted cell perimeter of the in-focus area of each optical section, and the original processed image of each optical section. To obtain a “direct image”, the reconstructed cell perimeter is superimposed upon the original processed image in each optical section, and those portions of the image outside of the perimeter (i.e., any out-of-focus portions of the cell image and all noncellular objects) are subtracted. This results in a direct image section which contains all of the original intracellular optical information (i.e., all of the grey scale information of the pixels inside the computed cell perimeter). The direct image sections are stacked and the resulting 3D reconstruction can be viewed from any angle. An interpolated direct image reconstruction also contains complete 3D grey scale information of all of the voxels (3D Pixels) in the interior of a living cell, and the resolution will depend primarily on the detail of the DIC images. Because the reconstructed 3D image is completely digitized in all directions, one can “peel open” the cell either horizontally, vertically or obliquely, or simply “gouge” the cell to any depth as it is crawling, and follow the dynamics of vesicles, mitochondria or nuclei (for example). Algorithms are implemented (in one embodiment) for z-axis interpolation, so that in side-views of direct image reconstructions, the surface of the cell appears contiguous, and in “gouged” or opened images of cells, internal structures are gap free. Such functionality is important for “virtual reality” displays (described in more detail below), where there are no limits to the viewer's position.

To reconstruct the nucleus of a translocating cell in 3D (in one embodiment), the perimeter of the nucleus in each optical section of the preprocessed movie is manually or automatically traced, depending upon the level of contrast at the nuclear membrane. Nuclear areas are then color coded in each direct image section of the cell. The 3D direct image reconstruction of the cell is then sectioned at any angle and to any depth in order to view at any angle both the direct image reconstruction of the crawling cell and the resident nucleus. A faceted reconstruction of the nucleus is then generated in a manner similar to that used for the cell surface, color coded, inserted into the faceted cell image and viewed from any angle. Finally, the 3D faceted nuclear image is reconstructed and viewed dynamically in the absence of the cell surface. Motility and morphology parameters can be computed from the 3D faceted image of the nucleus in the same manner as they are from the 3D image of the cell surface.

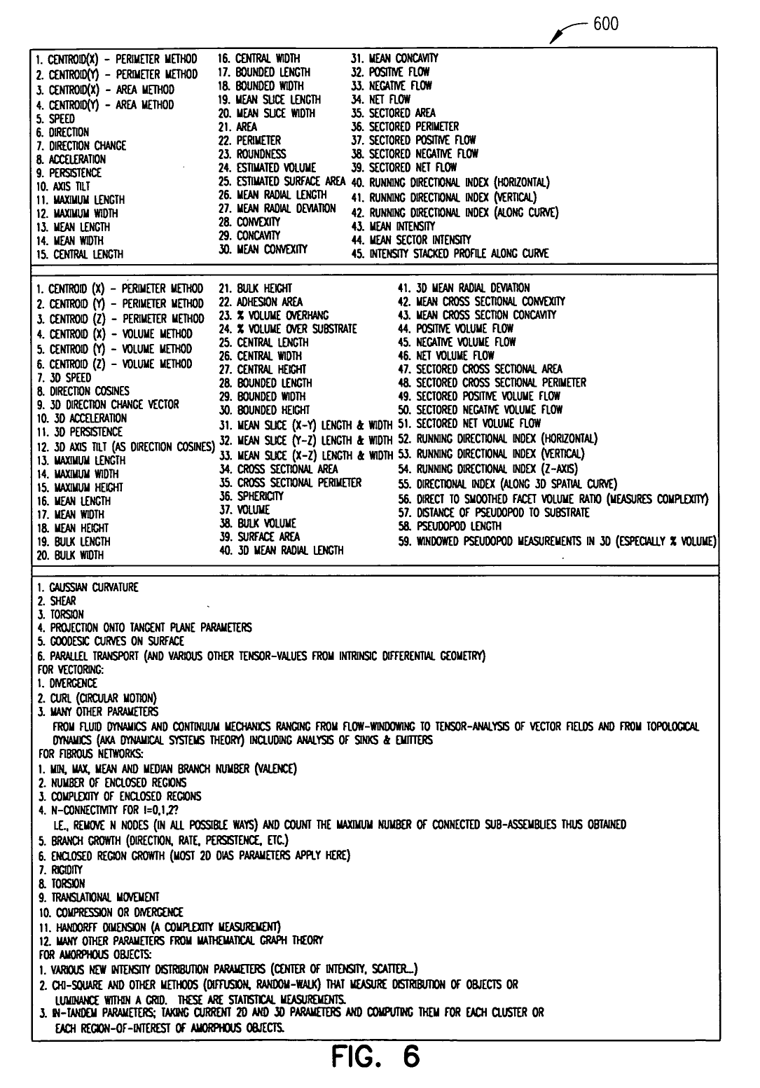

Another form of processing station that is supported in certain embodiments of the invention is the parameter computing station. Stations are provided for computing various 2D and 3D parameters. These provide quantitative analysis of cell behavior (e.g., motility and dynamic morphology parameters). FIG. 6 illustrates table 600 that includes a non-exclusive list of three sets of parameters that are computed, according to one embodiment.

A graphic display processing station is also provided in many embodiments. In these embodiments, there is an underlying database that contains not only data from different experiments (or sessions), but also functions for normalization that facilitate parallel presentations in the Notebook format. These functions are fast and automated for the rapid and retrospective comparison of data from different sources. These embodiments have the capacity to present motion analysis data in 2D and 3D graphic forms, has algorithms for smoothing, for the interpretation of peaks and troughs, for Fourier transforms and for correlation analysis. They also have the capacity to present data in tabular form, and programs for the synopsis of data. The forms of data presentation and analysis are implemented in the Notebook format. One implementation also supports a standard database manager (such as, for example, JBDC), so that a user may export, present, and analyze data using standard database software packages.

Such implementations are dynamic and flexible. They support many of the above-mentioned processing stations, but are also capable of supporting additional processing stations that may be created by the system, or by the user, to implement applicable or necessary functionality.

As noted several times already, various embodiments of the present invention are based on a parallel processing paradigm that implements a “Notebook” format. The “Notebook” provides a visual and functionally coherent container. It provides real-time interaction during the processing of each function. In the Notebook concept, a photo album is generated in which each experiment (or session) is represented as pages accessible by tabs. Each page contains one or more processing stations discussed above, and each processing station contains a number of tabs and controls that react immediately to the demands of the user.

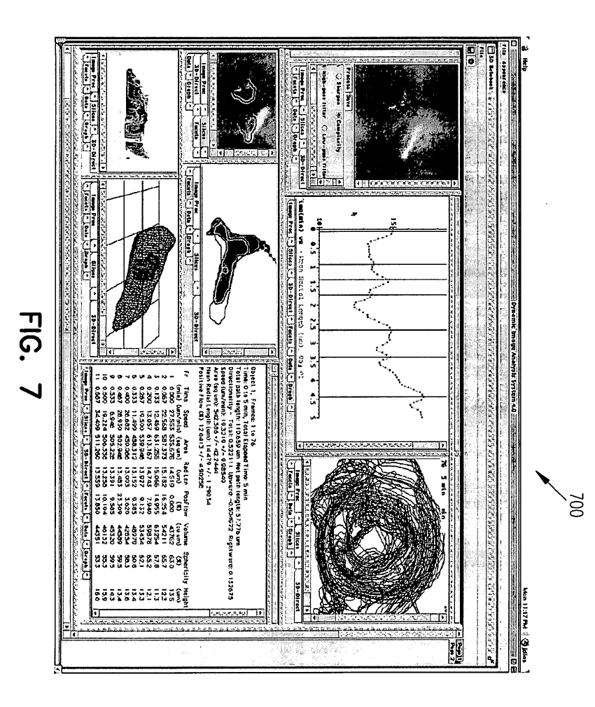

FIG. 7 illustrates a simulated notebook page, according to one embodiment of the present invention. In this embodiment, window 700 includes an example of a notebook page. A notebook page resembles a Mondrian painting in which some rectangles contain processing stations and others are left free to contain new stations. The rectangles may be exchanged or moved by drag-and-drop with the computer mouse. The size of each rectangle is controlled by manipulating the split-window bars. Windows may be exchanged between different pages of the Notebook, and new pages added to the Notebook. A collection of Notebook pages can be grouped into a sub-Notebook with associated tabs. A special control allows the user to select the dominant index scheme. Schemes can involve indexing by year, grant, experimenter, experiment, experimental regime, cell type, disease state, etc. This characteristic is extremely useful for retrospective comparisons.

The notebook page shown in FIG. 7 shows a moment in the dynamic processing of data of a motile cell. In reality, five windows of this page (excluding the tabular data, the wrapped perimeter plot and the graph) are evolving as the data are processed. Each window, therefore, presents a dynamic movie of the image or data in the act of being processed. Since all functions are performed in parallel and communicate through a control switchboard, an edit in one function can immediately impact the relevant data in another, if the user so directs.

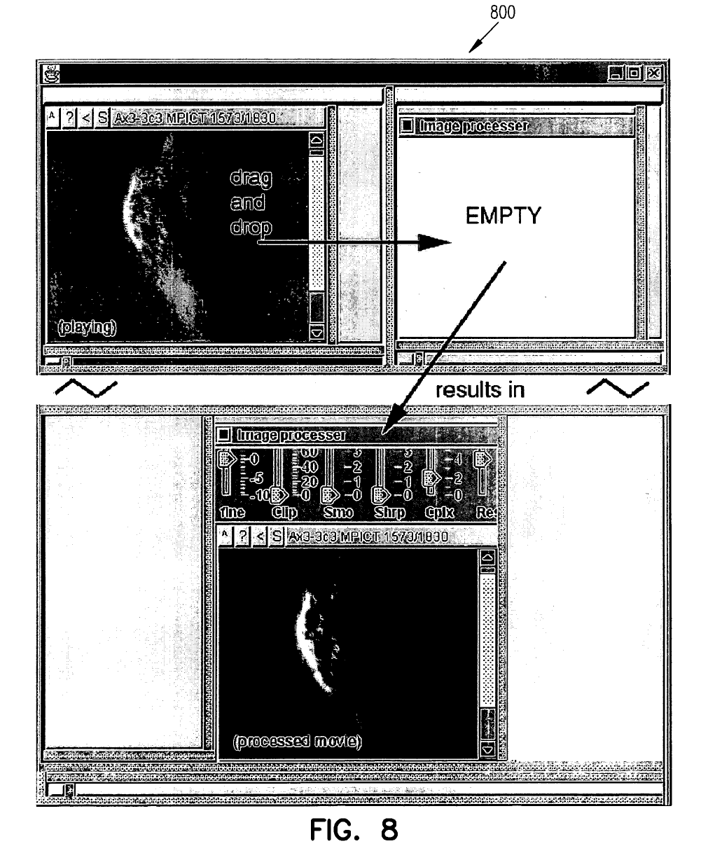

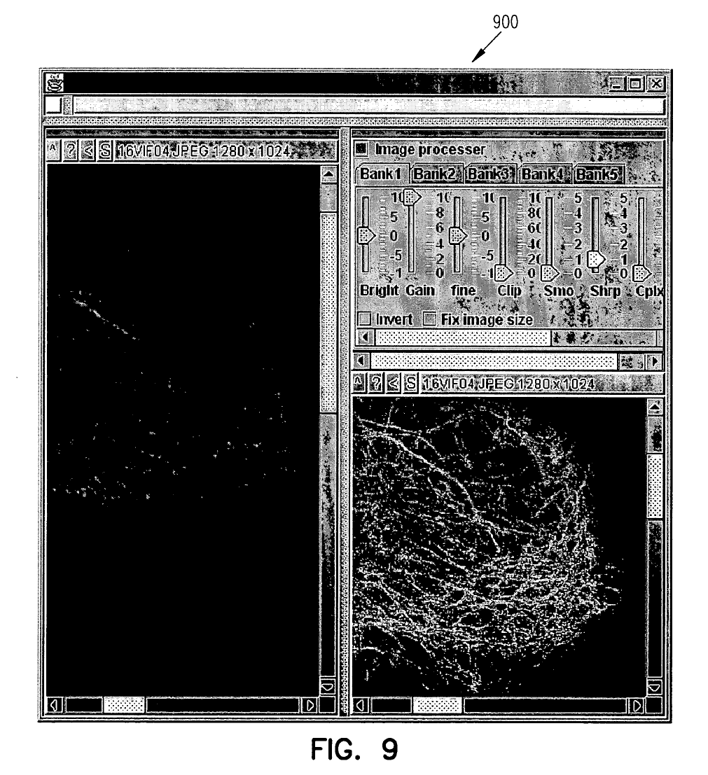

FIG. 8 illustrates a drag-and-drop operation of one or more digital representations into an image processor, according to one embodiment of the present invention. Notebook pages are constructed and remodeled based on the drag-and-drop paradigm. FIG. 8 demonstrates how a movie is dropped into a processor (each contained in window 800). The processor contains panels of controls, in this case for image processing. Controls are arranged in banks, which are activated by selecting the appropriate tab (e.g., see window 900 in FIG. 9, illustrating a panel of controls in a single processing station, according to one embodiment). The banked control panel concept allows the processor to contain hundreds of controls. Each “Bank” has a different variety of processing functions. The settings of the controls used in an experiment are then recorded in the notebook. This provides one with a history of manipulations for each experiment. The movie continues to play even as it is processed. Therefore, one can adjust controls for a dynamic image. Undoing a function is performed by simply dragging the movie or sub-process out of the processor, upon which the movie assumes its original state.

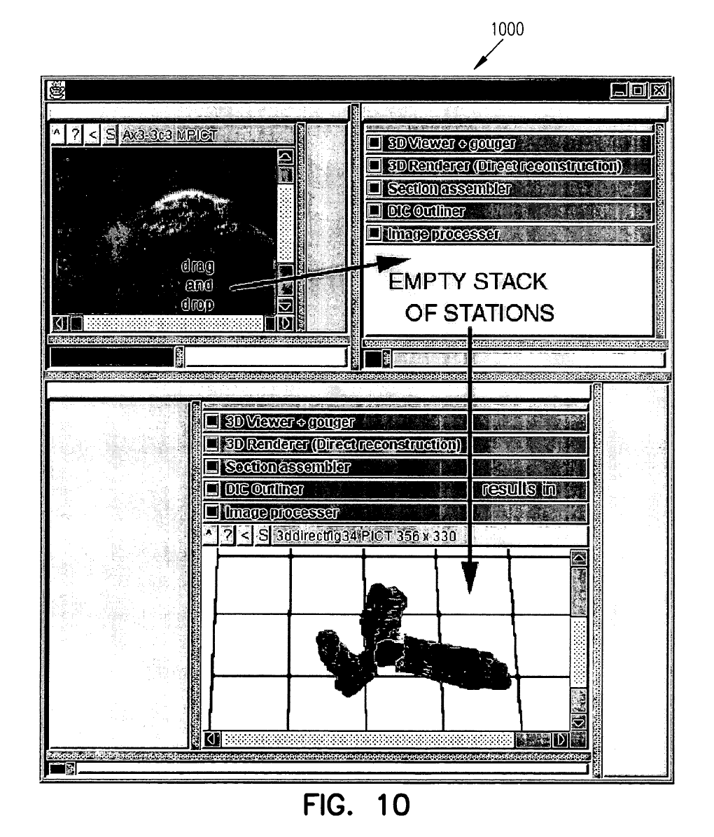

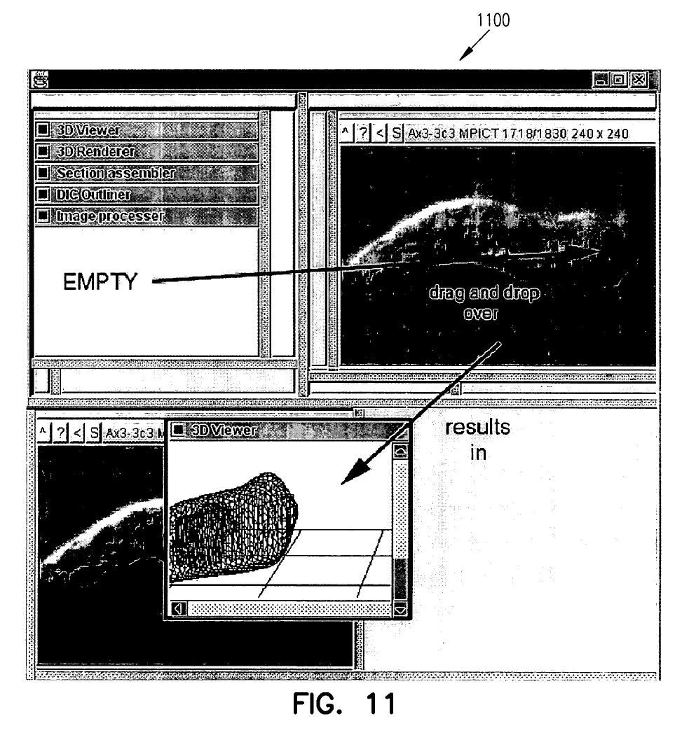

FIG. 10 illustrates a drag-and-drop operation of one or more digital representations into a stack of processing stations, according to one embodiment of the present invention. Processing stations can be stacked, or “nested”. FIG. 10 demonstrates how, in window 1000, a movie can be dragged and dropped into a stack of processors, causing the movie to be processed by all of the stacked functions. The order of processing is inside-out in accordance with the nested nature of the processors. Each of the stacked processors may be opened in order to manipulate its particular controls. During this procedure, the movie continues to play, allowing one to immediately assess the impact of the manipulation. The stack of processors can also be dragged over an entire movie, but more importantly, over a portion of a movie, such as a pseudopod (e.g., see window 1100 in FIG. 11, illustrating a drag-and-drop operation of a stack of processing stations over one or more digital representations, according to one embodiment). In addition to processing the image, this drag-and drop technique can be used with stations that compute motility parameters. This is demonstrated in window 1200 of FIG. 12 (illustrating a drag-and-drop operation of one or more digital representations into a station that computes motility parameters, according to one embodiment), where a movie is dragged into a stack of processors selected for 2D motion analysis.

In one implementation, pull-down menus are used to access or create the different processing stations. A user, however, may also double-click on an empty colored Mondrian square and select a new processor from a pop-up menu. The processors thus obtained may be arranged into stacks by drag-and-drop.

To futher describe the notebook concept according to various embodiments of the invention, it is noted that a notebook may contain any number of threaded (i.e. simultaneous) visual processes, a visual process being an original movie, image or abstract data that is contained in any number of nested processing stations. The visual part of the process is the result of the original data being processed by the chain of nested processing stations with each station having a collapseable control panel. The notebook can contain any number of empty Mondrian-style panes that will potentially contain processes. The squares may contain tabbed panes, with more squares in each tab. Any degree of nesting of these panes within other panes is allowed. Mirroring is also supported; any process may be broken off at any stage within the processing chain as a separate viewable process that may be itself processed in different ways, and so on. Thus, a single original content may be simultaneuosly processed (and viewed) in various ways. In sum, the components within the notebook support drag-and-drop (in such embodiments). The original data may be moved in or out of processor stations. The processing stations themselves may be moved as well as the empty Mondrian squares. Visual processing results are updated if the chain of processing is changed by the drag-and-drop operation. All animated content (movies and processed movies, for example) continue playing without interruption when the drag-and-drop is completed. In addition, the notebook is fully recursive. That is, a notebook can contain other notebooks and so on, the complexity being only limited to the space available on the computer monitor. The notebook may be saved and later restored (using customized serialization). Saving preserves the notebook exactly as it was. All processors retain their settings. All movies continue playing. All links to original content are updated, even if the content was moved to another location on the computer. If the content cannot be found, the user is prompted to provide it (by inserting backup media, in one implementation). The saving process is fast, with automatic backups being made periodically so that the notebook may be recovered in the event of a power failure, etc. The notebook is also robust. If any process within the notebook hangs, all the other processes in the notebook continue functioning.

A user is able to take a notebook home, or access a notebook via the web. In both cases, this can be achieved because the notebook, once established, is small, since it contains links to the actual data (in one embodiment) rather than containing the data itself. The data and movies may be either centrally archived or distributed. One can also generate a Notebook for presentation purposes.

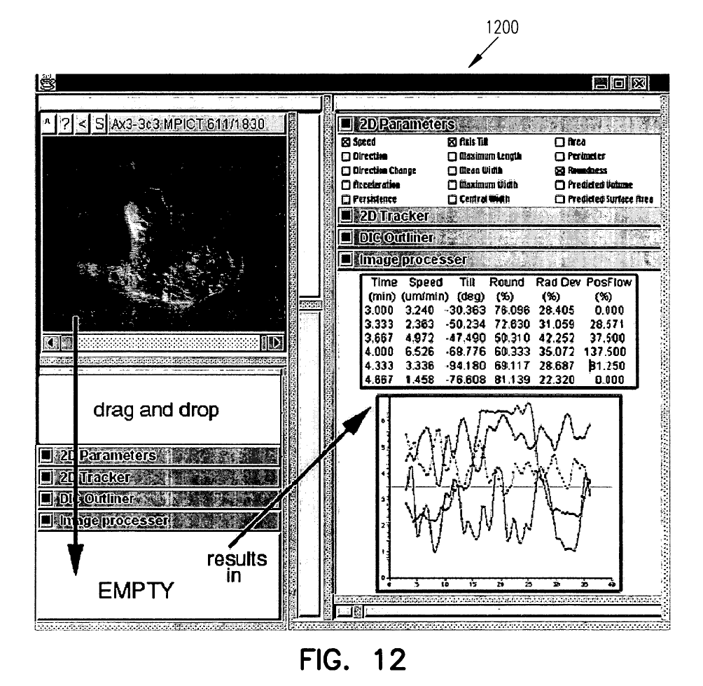

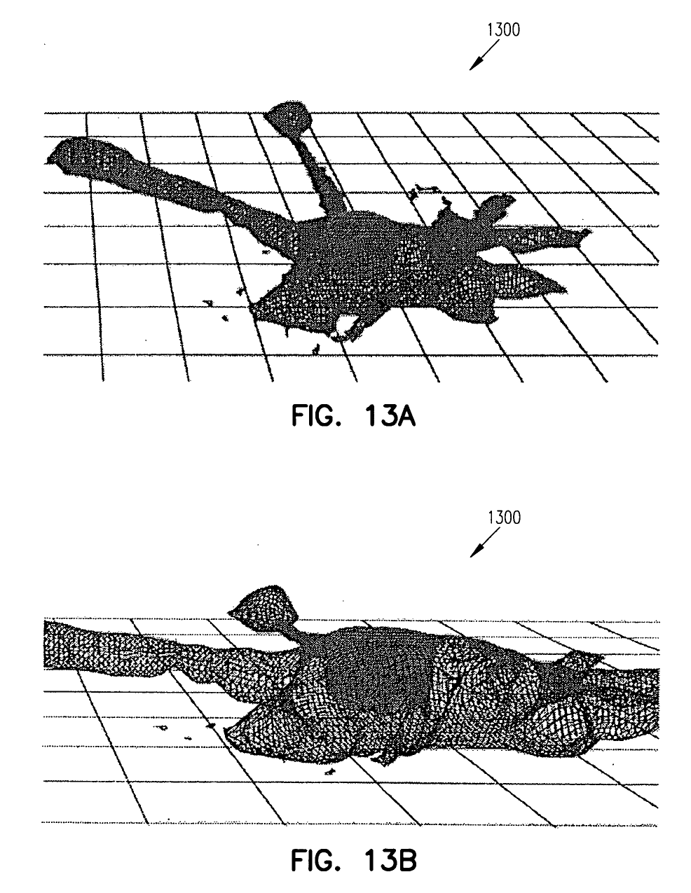

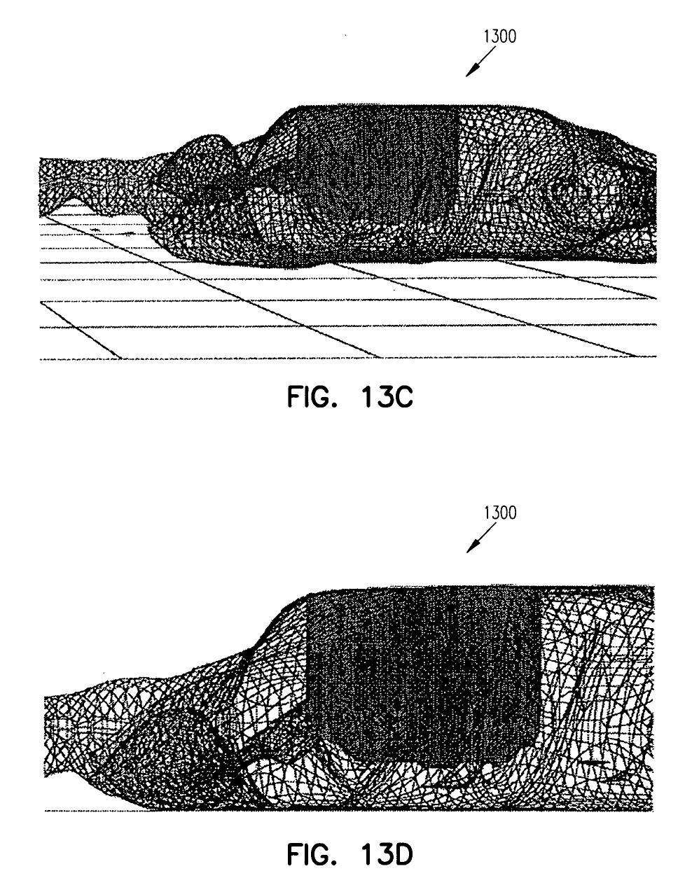

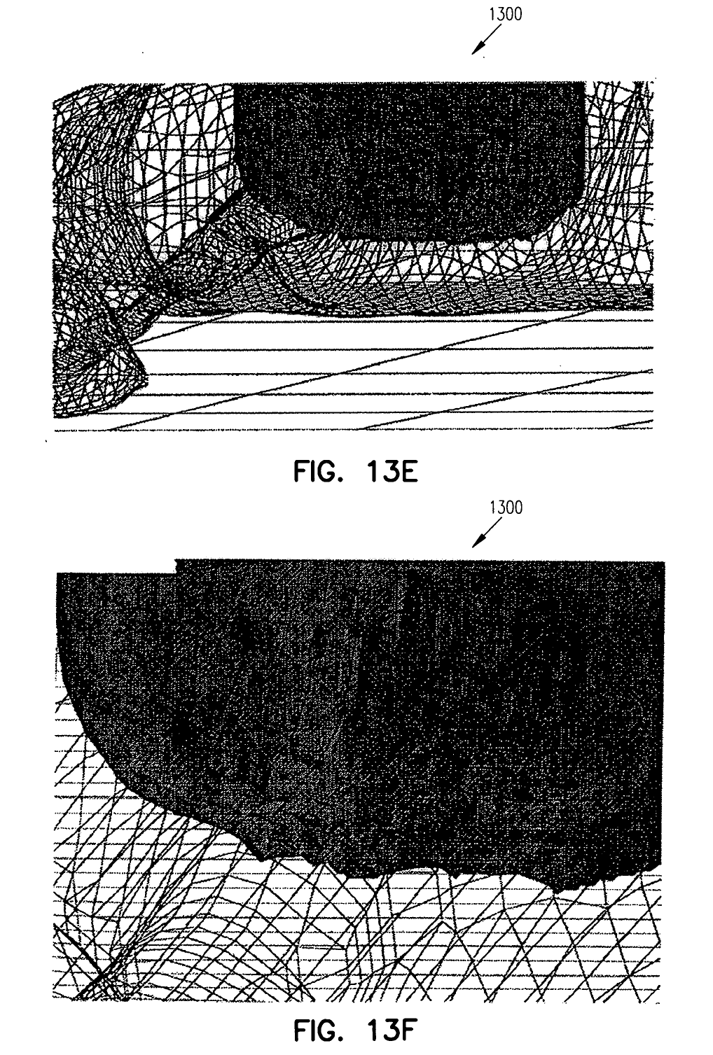

Certain embodiments of the present invention also provide “viral reality,” or “fly-by” views in three dimensions. These embodiments include virtual reality processing stations (or internal 3D rendering stations) that allow one not only to perform “fly-by” views of the cell from outside, but also allows the user to perform “fly-through” views within the cell. FIG. 13A through 13F illustrate a series of views along a trajectory, in which a viewer moves continuously closer to the underside of a live mammary tumor cell reconstructed in 3D, according to one embodiment of the present invention. These figures show, in example form, a sequence of views along a trajectory, in which the viewer moves continuously closer to the underside of a live mammary tumor cell (1300) reconstructed in 3D. The figures show “fly-by” views of a 3D-reconstruction of the mammary tumor cell. The increase in the size of the nucleus and the view from under the cell provide just an inkling of what things look like as one strolls through a cell in a “virtual reality theater.”

As the viewer moves through a direct image 3D reconstruction, the neighborhood immediately surrounding the viewer disappears, revealing the dense detail of architecture at the neighborhood boundary. Edge enhancement with color-tone assignments is used to discern pixel density in the region in front of the viewer as he or she moves through the cell interior. The viewer may move through a static reconstruction of the cell at a single time point or as the cell is moving and the internal architecture is reorganizing (a sequence of time-linked reconstructions).

In a similar fashion, the low pixel complexity components of a cell in a direct image reconstruction, or, in a faceted image, the reconstructed and reinserted cell components change transparency as the viewer moves along a path through a static or moving cell.

Alternatively, by converting regions of low pixel complexity of a direct image reconstruction to empty space, the viewer can examine the dynamics of high complexity objects, such as vesicles and the nucleus within the plasma membrane. Alternatively, areas of very low pixel complexity can be imaged, and all high complexity detail removed in order to view the dynamic extension and retraction of the pseudopodial zones containing particulate-free cytoplasm.

In a faceted reconstruction, only the nucleus, vesicles, the nonparticulate cytoplasmic zone of pseudopods, or any combination of these structures, can be inserted, and the viewer stationed at a particular point in the cell as it crawls.

Fluorescently stained regions of a cell are likewise inserted into faceted images and color-coded. In this way, the dynamic changes in molecular complexes, the trans Golgi complex, microtubule arrays, intermediate filament arrays and microfilament complexes can be monitored from inside the cell. DIC imaged components, like the nucleus or vesicles, can also be inserted in these reconstructions for parallel viewing. Once 3D “iron filings” images are generated, they can also be inserted into cells and the viewer can watch them assemble and disassemble from within the cell at any vantage point.

The viewer is also able to prescribe what he or she will view before entering the cell. The viewer will also be able to point to objects, surfaces or contours, and then select parameters from a projected list that is computed for the indicated object. The value of such parameters can be coded as color shades and levels of opacity directly into the desired object or detail, providing a 3D representation of the level of a parameter simultaneously with the dynamic 3D structure.

Various embodiments of the present invention also provide 3D “difference” images. A difference picture is a composite of the outlines of the peripheries of the cell at two sequential time points. Two 3D faceted (or caged) images from two different time points (or frames) are superimposed. By superimposing the later frame on the earlier frame, and by color-coding “expansion zones” (regions of the later cell image not overlapping the earlier cell image) as green areas and “contraction zones” (regions of the earlier cell image not overlapping the later cell image) as red areas, one thereby generates a difference picture. The area that is common to both will be colored gray. In 3D, the gray area is entirely interior, so the green and red areas are made semi-transparent or sliced to reveal the common portion. The total area of expansion or contraction per unit time are automatically computed as “positive flow” and “negative flow”, respectively, for each time interval. A window, in one implementation, is assigned to a particular pseudopod of a cell or portion of the growth cone of an axon, and each specific expansion and contraction zone computed as percent total cell area per unit time. Difference pictures provide a unique view of how cells crawl, and “dynamic difference pictures” in video movie format provide unique insights into the localized dynamics of cytoplasmic flow during cellular translocation.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. Therefore, it is intended that this invention be limited only by the claims and the equivalents thereof.

What is claimed is:

1. A computerized method for dynamically analyzing a mobile object, the computerized method comprising:
obtaining a plurality of digital representations of the mobile object;
establishing a first and a second processing station in a session;
processing the digital representations on the first processing station;
processing in parallel the digital representations on the second processing station to compute a plurality of parameters representing a motility or morphology of the mobile object; and
displaying a graphical reconstruction of the mobile object.

2. The computerized method of claim 1, further comprising establishing one or more control panels to control various functionalities of the first and second processing stations.

3. The computerized method of claim 1, further comprising preserving the first and second processing stations in the session.

4. The computerized method of claim 1, wherein the processing of the digital representations on the first processing station includes outlining the mobile object in the first processing station using an outlining algorithm on the digital representations.

5. The computerized method of claim 4, wherein the outlining of the mobile object in the first processing station includes using an outlining algorithm for outlining a fibrous structure.

6. The computerized method of claim 4, wherein the outlining of the mobile object in the first processing station includes using a complexity algorithm that is controlled in real-time using the one or more control panels.

7. The computerized method of claim 4, wherein the outlining of the mobile object in the first processing station includes using a thresholding algorithm that provides an outline based on pixel intensity.

8. The computerized method of claim 4, wherein the outlining of the mobile object in the first processing station includes using a gradient algorithm that provides an outline based on a steepness of change in pixel intensity.

9. The computerized method of claim 4, wherein the outlining of the mobile object in the first processing station includes using an interior hole algorithm to select a center point of one image of the mobile object, invert the image around the center point to create an inverted image, outline the inverted image using a thresholding algorithm, and re-invert the inverted image to create an output image.

10. The computerized method of claim 1, wherein the processing of the digital representations on the first processing station includes displaying a plurality of images of the digital representations on an image station.

11. The computerized method of claim 1, wherein the processing in parallel of the digital representations on the second processing station to compute the plurality of parameters representing the motility or morphology of the mobile object includes computing parameters for vectoring, fibrous networks, and amorphous objects.

12. The computerized method of claim 1, wherein the displaying of the graphical reconstruction of the mobile object includes displaying the graphical reconstruction of the mobile object in a graphic display station.

13. The computerized method of claim 1, wherein the displaying of the graphical reconstruction of the mobile object includes displaying a direct image reconstruction of the mobile object.

14. The computerized method of claim 1, wherein the displaying of the graphical reconstruction of the mobile object includes displaying a partially transparent faceted reconstruction of a surface of a cell.

15. The computerized method of claim 1, wherein the displaying of the graphical reconstruction of the mobile object includes displaying a non-transparent or solid faceted reconstruction of a nuclei of a cell.

16. A computerized method for dynamically analyzing a mobile object in three dimensions, the computerized method comprising:
obtaining a plurality of digital representations of the mobile object;
establishing a first and a second processing station in a first session;
processing the digital representations on the first processing station;
simultaneously processing the digital representations on the second processing station;
displaying a three-dimensional graphical reconstruction of the mobile object; and
preserving the first and second processing stations in the first session.

17. The computerized method of claim 16, wherein the establishing of the first and the second processing station includes establishing one or more control panels to control different functionalities of the processing stations.

18. The computerized method of claim 17, wherein the processing of the digital representations on the first processing station includes changing a setting of one of the control panels, and wherein the changing of the setting of one or the control panels causes a change in the simultaneous processing of the digital representations on the second processing station.

19. The computerized method of claim 18, wherein the storing of the first and second processing stations in the first session includes storing all settings of the control panels.

20. The computerized method of claim 16, wherein the establishing of the first and the second processing station includes establishing the second processing station within the first processing station to create a nested processing station functionality.

21. The computerized method of claim 16, wherein the processing of the digital representations on the first processing station includes
establishing a third and a fourth processing station within the first processing station,
processing the digital representations on the third processing station, and
simultaneously processing the digital representations on the fourth processing station.

22. The computerized method of claim 16, wherein the processing of the digital representations on the first processing station includes initiating the processing of the digital representations on the first processing station as a result of a drag-and-drop operation.

23. The computerized method of claim 16, wherein the preserving of the first and second processing stations in the first session includes
pausing the processing of the digital representations on the first processing station at a first time period, and
resuming the processing of the digital representations on the first processing station at a second time period.

24. The computerized method of claim 23, wherein the pausing includes saving the processing of the digital representations on the first processing station to a computer-readable medium.

25. The computerized method of claim 24, wherein the resuming includes restoring from the computer-readable medium the processing of the digital representations on the first processing station.

26. The computerized method of claim 16, wherein the preserving of the first and second processing stations in the first session includes preserving the first session in a simulated notebook.

27. The computerized method of claim 26, further comprising:
establishing a third and a fourth processing station in a second session;
processing the digital representations on the third processing station;
simultaneously processing the digital representations on the fourth processing station; and
preserving the third and fourth processing stations of the second session in the simulated notebook.

28. The computerized method of claim 16, wherein the processing of the digital representations on the first processing station includes displaying the digital representations on an image station.

29. The computerized method of claim 16, wherein the processing of the digital representations on the first processing station includes processing the digital representations on an outlining station.

30. The computerized method of claim 16, wherein the processing of the digital representations on the first processing station includes processing the digital representations on a vectoring station.

31. The computerized method of claim 16, wherein the processing of the digital representations on the first processing station includes processing the digital representations on an internal three-dimensional rendering station.

32. The computerized method of claim 16, wherein the processing of the digital representations on the first processing station includes processing the digital representations on a parameter computation station.

33. The computerized method of claim 16, wherein the processing of the digital representations on the first processing station includes processing the digital representations on an image station.

34. The computerized method of claim 16, wherein the displaying includes displaying the three-dimensional graphical reconstruction of the mobile object in a graphic display station included in the first processing station.

35. A method for dynamically outlining and displaying a moving object in three dimensions, the method comprising:
obtaining a first series of images of the moving object;
obtaining a second series of images of the moving object;
establishing a first and a second outlining processing station;
outlining the moving object in the first outlining processing station using an outlining algorithm on the first series of images;
outlining the moving object in the second outlining processing station using a different outlining algorithm on the second series of images;
displaying a three-dimensional graphical representation of the moving object that is a function of the outlining of the moving object in the first and second outlining processing stations.

36. The method of claim 35, wherein the obtaining of the first series of images includes obtaining a series of images of a fibrous structure of the moving object, and wherein the outlining of the moving object in the first outlining processing station includes implementing an algorithm for outlining the fibrous structure.

37. The method of claim 35, wherein the outlining of the moving object in the first outlining processing station includes implementing a complexity algorithm that is controlled in real-time using one or more control panels of the first outlining processing station.

38. The method of claim 35, wherein the outlining of the moving object in the first outlining processing station includes implementing a thresholding algorithm that provides an outline based on pixel intensity.

39. The method of claim 35, wherein the outlining of the moving object in the first outlining processing station includes implementing a gradient algorithm that provides an outline based on a steepness of change in pixel intensity.

40. The method of claim 35, wherein the outlining of the moving object in the first outlining processing station includes implementing an interior hole algorithm to select a center point of one image of the moving object, invert the image around the center point to create an inverted image, outline the inverted image using a thresholding algorithm, and re-invert the inverted image to create an output image.

41. A computerized method for dynamically outlining and displaying a moving object in three dimensions, the method comprising:
obtaining a plurality of images of the moving object, the moving object having a fibrous structure;
establishing an outlining processing station to outline fibrous structures;
generating a plurality of computerized particles;
dispersing the computerized particles over a portion of the images of the moving object;
measuring a plurality of concentrations and a plurality of alignments of the computerized particles;
graphing the concentrations and alignments of the computerized particles; and
displaying a three-dimensional graphical representation of the moving object.

42. The computerized method of claim 41, further comprising calculating a plurality of parameters representing a motility or morphology of the moving object.

43. A computerized method for dynamically analyzing a lineage of a moving cell in three dimensions, the computerized method comprising:
obtaining a plurality of first digital representations of the moving cell during a first time interval;
outlining the moving cell in a first processing station using an outlining algorithm on the digital representations;
processing the digital representations in a second processing station to compute a plurality of parameters representing a motility or morphology of the moving cell;
displaying a three-dimensional graphical reconstruction of the moving cell;
preserving the first and second processing stations; and
repeating the obtaining, outlining, processing, displaying, and preserving of a plurality of second digital representations of the moving cell during a second time interval to observe the lineage of the moving cell over time.

44. A method for providing a difference image of a moving object in two or three dimensions, the method comprising:
obtaining a first image of the moving object at a first time period;
processing the first image of the moving object;
displaying a first three-dimensional graphical reconstruction of the moving object;
repeating the obtaining and processing of a second image at a second time period to display a second three-dimensional graphical reconstruction of the moving object; and
displaying a three-dimensional difference image, the three-dimensional difference image representing a three-dimensional change in motility or morphology of the moving object.

45. The method of claim 44, wherein the processing of the first image includes
displaying the first image of the moving object,
outlining a periphery of the first image of the moving object, and
calculating a plurality of parameters representing a motility or morphology of the moving object.

46. The method of claim 44, wherein the displaying of the three-dimensional difference image includes
outlining a periphery of the first image of the moving object,
outlining a periphery of the second image of the moving object,
using a first color to display a first area common to both peripheries,
using a second color to display a second area, the second area included inside the periphery of the first image but outside the periphery of the second image, and
using a third color to display a third area, the third area included inside the periphery of the second image but outside the periphery of the first image.

47. The method of claim 44, wherein the obtaining of the first image includes
optically sectioning the moving object at a plurality of focal depths over the first period of time to create a plurality of optical sections, and
digitizing each of the plurality of optical sections to create a plurality of digitized optical sections.

48. The method of claim 47, wherein the optical sectioning includes optically sectioning the moving object by using a differential interference contrast equipped microscope controlled by a stepper motor.

49. The method of claim 47, wherein the digitizing includes digitizing each of the optical sections by using a frame grabber to grab and compress a plurality of frames.

50. The method of claim 44, wherein the obtaining of the first image includes obtaining a plurality of digitized optical sections of the first image.

51. The method of claim 50, wherein the obtaining of the plurality of digitized optical sections of the first image includes obtaining a plurality of graphic image files.

52. The method of claim 50, wherein the obtaining of the plurality of digitized optical sections of the first image includes obtaining a multimedia movie file.

53. The method of claim 44, wherein the displaying of the first three-dimensional graphical reconstruction includes displaying the first three-dimensional graphical reconstruction that includes only a portion of the moving object.

54. The method of claim 44, wherein the displaying of the first three-dimensional graphical reconstruction includes displaying a three-dimensional elapsed time stacked image reconstruction.

55. The method of claim 44, wherein the displaying of the first three-dimensional graphical reconstruction includes displaying a three-dimensional elapsed time faceted image reconstruction.

56. A computerized method for providing an internal three-dimensional view of a mobile object, the computerized method comprising:
obtaining a plurality of digital representations of the mobile object;
establishing a virtual experiment;
establishing an outlining and an internal three-dimensional rendering station in the virtual experiment;
establishing one or more control panels to control various functionalities of the outlining and internal three-dimensional rendering stations;
outlining the mobile object in the outlining station using an outlining algorithm on the digital representations;
processing in parallel the digital representations on the internal three-dimensional rendering station; and
displaying an internal three-dimensional graphical reconstruction that shows an internal view of the mobile object.

57. The computerized method of claim 56, further comprising preserving the outlining and internal three-dimensional rendering stations in the virtual experiment.

58. The computerized method of claim 56, wherein the displaying of the internal three-dimensional graphical reconstruction includes displaying the internal three-dimensional graphical reconstruction on a graphic display station in the virtual experiment.

59. A dynamic analysis system, comprising:
a memory,
a storage device;
a display unit; and
a processor programmed to
obtain a plurality of digital representations of a mobile object,
establish a first session,
establish a first and a second processing station in the first session,
process the digital representations on the first processing station,
simultaneously process the digital representations on the second processing station,
display a three-dimensional graphical reconstruction of the mobile object, and
preserve the first and second processing stations in the first session.

60. A dynamic analysis system, comprising:
a first component operative to obtain a plurality of digital representations of a mobile object;
a second component operative to process the digital representations on a first station;
a third component operative to process in parallel the digital representations on a second station to compute a plurality of parameters representing a motility or morphology of the mobile object; and
a fourth component operative to display a three-dimensional graphical reconstruction of the mobile object.

61. The dynamic analysis system of claim 60, further comprising a fifth component operative to preserve the first and second stations.

62. A system comprising:
a communication network;
one or more processing nodes coupled to the communication network;
a user node;
a display coupled to the user node; and
software operable on the one or more processing nodes to
obtain a plurality of digital representations of a mobile object,
establish a first session,
establish a first and a second processing station in the first session,
process the digital representations on the first processing station,
simultaneously process the digital representations on the second processing station,
display a three-dimensional graphical reconstruction of the mobile object, and preserve the first and second processing stations in the first session.

63. A system comprising:
a communication network;
one or more processing nodes coupled to the communication network;
a user node;
a display coupled to the user node; and
software operable on the one or more processing nodes to
obtain a plurality of digital representations of a mobile object,
establish a virtual experiment,
establish a first and a second processing station in the virtual experiment,
establish one or more control panels to control various functionalities of the first and second processing stations,
outline the mobile object in the first processing station using an outlining algorithm on the digital representations,
process in parallel the digital representations on the second processing station, and
display a graphical reconstruction of the mobile object.

64. The system of claim 63, wherein the software is further operable on the one or more processing nodes to preserve the first and second processing stations in the virtual experiment.

65. A three-dimensional dynamic image analysis system, comprising:
means for obtaining a plurality of digital representations of a mobile object;
means for producing a three-dimensional display, and
a computer system operable to perform a set of instructions to
establish a first virtual experiment,
establish a first and a second processing station in the first virtual experiment,
process the digital representations on the first processing station,
simultaneously process the digital representations on the second processing station,
display a three-dimensional graphical reconstruction of the mobile object, and
preserve the first and second processing stations in the first virtual experiment.

66. A three-dimensional dynamic image analysis system, comprising:
means for obtaining a plurality of digital representations of a mobile object;
means for processing the digital representations on a first station;
means for simultaneously processing the digital representations on a second station;
means for displaying a three-dimensional graphical reconstruction of the mobile object; and
means for preserving the first and second stations.

67. A computer-readable medium having computer-executable instructions stored thereon to perform a method, the method comprising:
obtaining a plurality of digital representations of a mobile object;
establishing a session;
establishing a first and a second processing station in the session;
establishing one or more control panels to control various functionalities of the first and second processing stations;
outlining the mobile object in the first processing station using an outlining algorithm on the digital representations;
processing in parallel the digital representations on the second processing station; and
displaying a graphical reconstruction of the mobile object.

68. The computer-readable medium of claim 67, wherein the method performed further includes preserving the first and second processing stations in the session.

69. In a computerized system having a graphical user interface including a display and a pointing device, a method for processing a series of digital representations of a mobile object on the display, the method comprising:
displaying a session;
displaying a first and a second processing station within the session;
dragging and dropping the series of digital representations onto both the first and second processing stations;
processing the series of digital representations on the first processing station;
processing in parallel the series of digital representations on the second processing station; and
displaying a graphical reconstruction of the moving object.

70. The method of claim 69, further comprising displaying one or more control panels that control various functionalities of the first and second processing stations.

71. The method of claim 69, further comprising preserving the first and second processing stations in the session.

72. The method of claim 69, further comprising:
displaying a third and a fourth processing station within the session;
dragging and dropping the third processing station onto the fourth processing station to create a complex processing station;
dragging and dropping the series of digital representations onto the complex processing station; and
processing the series of digital representations on the complex processing station.

73. The method of claim 69, wherein the displaying of the graphical reconstruction of the moving object includes displaying a three-dimensional graphical reconstruction of the moving object.

74. In a computerized system having a graphical user interface including a display and a selection device, a method for processing a series of digital representations of a mobile object on the display, the method comprising:
displaying a virtual experiment;
displaying a first and a second processing station within the virtual experiment;
dragging and dropping the first and second processing stations onto a portion of the series of digital representations;
processing the portion of the series of digital representations on the first processing station;
processing in parallel the portion of the series of digital representations on the second processing station; and
displaying a graphical reconstruction of a portion of the moving object.

75. The method of claim 74, further comprising displaying one or more control panels that control various functionalities of the first and second processing stations.

76. The method of claim 74, further comprising preserving the first and second processing stations in the virtual experiment.

77. The method of claim 74, wherein the displaying of the graphical reconstruction of the portion of the moving object includes displaying a three-dimensional graphical reconstruction of the portion of the moving object.

78. A method for displaying a moving object in three dimensions, the method comprising:
obtaining a first series of images of a first portion of the moving object;
obtaining a second series of images of a second portion of the moving object;
establishing an outlining processing station;
establishing a vectoring processing station;
outlining the first series of images in the outlining processing station using an outlining method;
computing vector information for the second series of images in the vectoring processing station using a vector flow method;
displaying a dimensional graphical representation of the first and second portions of the moving object that is a function of the outlining in the outlining processing station and the computing in the vectoring processing station.

79. The method of claim 78, wherein the obtaining of the second series of images of the second portion of the moving object includes obtaining the second series of images of an amorphous portion of the moving object.

80. The method of claim 78, wherein the displaying of the three-dimensional graphical representation of the first and second portions of the moving object includes displaying the three-dimensional graphical representation as a combination of direct reconstruction, caging, and vector display regions.

81. The method of claim 80, wherein the displaying of the vector display region of the three-dimensional graphical representation includes displaying the vector display region as a doppler region.
